(19) United States
(12) Patent Application Publication
(10) Pub. No.: US 2002/0149198 A1
(43) Pub. Date: Oct. 17, 2002

(54) Business card and ruler combination

(76) Inventor: Larry Kenneth Legg, Perry, OH (US)

Correspondence Address: LOUIS F WAGNER, BUCKINGHAM DOOLITTLE & BURROUGHS, LLP, 50 S MAIN STREET, P O BOX 1500, AKRON, OH, 44309-1500, US

(21) Appl. No.: 09/826,794

(22) Filed: Apr. 5, 2001

(51) Int. Cl. B42D 15/00

(52) U.S. Cl. 283/115

(57) ABSTRACT

The invention relates to a combination business card/expandable ruler capable of being folded into a wallet-size business card. The card can also be expanded for use as a ruler in either inch measurements or centimeter measurements. Business card identification information is printed on the top surface which secures into a semi-circular shaped slit when the tripartite ruler is collapsed into a business card size.

### TECHNICAL FIELD

The invention relates to a business card which expands into a ruler.

### BACKGROUND OF THE INVENTION

Business cards are used throughout the world and are universally accepted to represent a company, its product(s), and its representatives or agents when initiating a first client/customer contact, at business meetings, at conventions, at society and trade organization meetings, and at social events. Presently, executives and salesmen use their business cards in conjunction with various electronic message devices such as videotapes, audio tapes, audio brochures and talking cards having a voice chip for depicting a company's product(s), celebrity or athletic stars, vacation destinations, real estate properties, and the like. They are used to indicate their advantages, usages, history, accomplishments, value, accommodations, or house locations, such that a potential client/customer can listen to and/or see the desired information needed to make an intelligent and informed choice and/or decision for that product or service.

The use of business cards to try and obtain a first meeting with the potential customer/client may take several visits to the customer's home or client's office where the salesman leaves the business card at each attempt with the office manager, receptionist or secretary. Salesmen or executives do not usually leave the aforementioned electronic message devices with the office manager, receptionist or secretary until a first meeting with the customer/client wanted to be seen (the correct decision maker) has taken place. Typically, the business card or such electronic message devices if left by the salesman do not get passed on to the customer/client decision maker and these electronic message devices and/or business cards (inexpensive) are usually thrown away without being seen or heard at a considerable expense to the company using such advertising and promotional materials. Business cards alone, or business cards accompanied by other promotional materials, as previously mentioned, do not usually get that first appointment with the decision maker needed to be seen. Every attempt at a visit by a salesman costs the company time, money, and materials which affects the profitability of the company. There remains a need for a self-contained electronic message emitting device in the form of a talking business card having a voice and/or sound message related to the business indicia depicted on the face of the business card. The talking business card would quickly (typically in less than 120 seconds) introduce the company's product(s) or services to the customer/client in need of the product(s) or services for obtaining the first meeting between the salesman and the ultimate customer/client purchaser.

The business card/ruler was designed for the convenience of carrying a wallet-size business card with the practical use of an expandable ruler. The card/ruler is designed to remain in the business card size by folding the card and positioning two ends of the ruler into oppositely facing semi-circular shaped slits.

### SUMMARY OF THE INVENTION

The invention is a business card/ruler combination which incorporates a foldable and expandable ruler into a business card for ease of carrying in a wallet. It provides an alternative for carrying other measuring tools which are not as flexible or which cannot be carried with ease. Typical Business card identification indicia is printed on a top surface of the card while numeric measuring units are printed on an opposed side. The tripartite card opens up to form a ruler which measures in inches or centimeters.

These and other objects of this invention will be evident when viewed in light of the drawings, detailed description, and appended claims.

### BRIEF DESCRIPTION OF THE DRAWINGS

The invention may take physical form in certain parts and arrangements of parts, a preferred embodiment of which will be described in detail in the specification and illustrated in the accompanying drawings, which form a part hereof, and wherein:

FIG. 1 is a face plan view of a new configuration for a business card/ruler combination;

FIG. 2 is a back plan view of the card illustrated in FIG. 1 as such may be flipped over from left-to-right; and

FIG. 3 is an inside plan view of the card as it may be opened to expose a pair of rulers which form part and parcel of the combination.

### DETAILED DESCRIPTION OF THE INVENTION

Referring now to the drawings wherein the showings are for purposes of illustrating the preferred embodiment of the invention only, and not for purposes of limiting the same, the Figures show the combination business card/ruler of the instant invention.

In general, the multi-purpose business card 50 is a relatively thin strip of cardstock having at least two fold lines 11,13. In one embodiment of the invention, the cardstock will be plasticized, and in yet another embodiment, the cardstock is replaced with a thin flexible polymer. In still yet another embodiment of the invention, the business card will be made of two different polymers, which are coextruded, one relatively rigid polymer for the side and middle portions of the card and another relatively more flexible polymer for the fold lines.

When fully extended, the business card will have a top face 2 and a bottom face 4, each face terminating at side edges 12,14 each face additionally having longitudinal edges 16,16′. In a preferred embodiment, the top and bottom faces of the card are segmented into three parts separated by fold lines. It is recognized that while three segments are shown in FIG. 3, the number of segments could be increased or decreased. If there are only two segments, the card will have only one fold line. If there are four segments, there will be three fold lines. It can be seen that for n segments, there will be n−1 fold lines provided that n is an integer greater than or equal to 2.

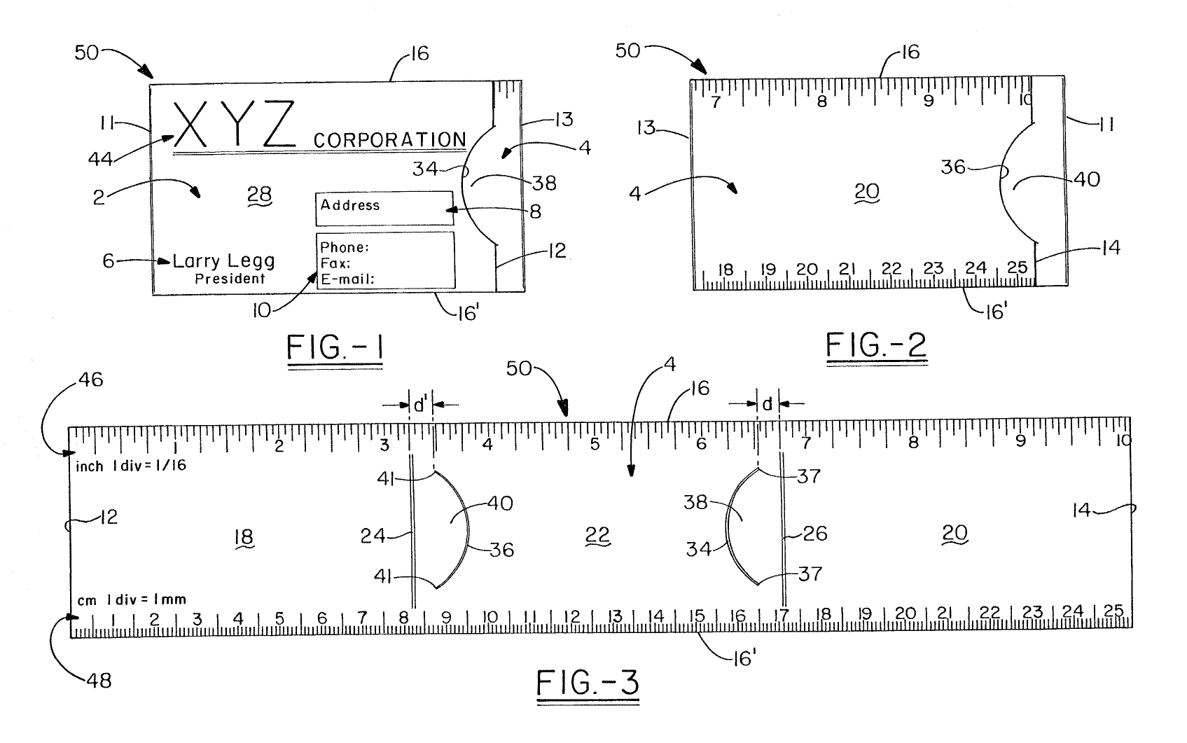

As illustrated in FIG. 3 showing only the bottom face of the card, three segments, two bottom end segments 18,20 with an interposed bottom middle segment 22, are illustrated, each segment separated by a fold line 24,26. The top side of the card would have matching top end segments 28,30 (not shown) with an interposed top middle segment 32 (not shown), only one top end segment 28 being illustrated in a folded configuration in FIG. 1. The length of end segments 18,20 is slightly less than that of middle segment 22. This is necessitated by the fact that after insertion of side edge 12 into slot 34, for end segment 18,28 to lie flat, it must be shorter by a distance d, measured as the length between the terminal edge opening 37 of flap 38. Similarly, it is seen that in order for end segment 20,30 to lie flat after insertion of side edge 14 into slot 36, it must be shorter by a distance d′, measured as the length between the terminal edge opening 41 of flap 40. While often d and d′ are equal, there is no need to limit the invention to such a relationship.

As seen in the figure, top surface 2 of one top end segment 28 of a representative business card 50 is shown having typical business identification information printed thereupon. This identifying indicia typically includes a company name 44, optionally in stylized font and optionally including a corporate design or logo, an individual's name and title 6, the corporate address 8, phone number, fax number and e-mail 10. As viewed in the figure, at least a portion of side edge 12 of the business card is at least partially inserted into a semi-circular shaped slit 34 to secure that end of the card into a middle back portion 22 of the card by flap 38.

FIGS. 2 and 3 illustrate the rear surface of the folded card. The top longitudinal edge 16 of segments 18,20,22 of the tripartite ruler displays English unit measurements (inches) 46 terminating at 10 inches, the subdivision unit being identified as 1/16 in an uppermost left section of bottom side segment 18. The bottom longitudinal edge 16′, of segments 18,20,22 displays corresponding metric unit measurements 48, the subdivision unit being identified as 1 mm in a lowermost left section of bottom side segment 18 of the English unit measurements shown above.

As best shown in FIG. 3, middle segment 22 of the bottom side 4 contains two oppositely facing semi-circular slits 34,36 each slit defining a flap 38,40 respectively. These slits are cut completely through the segment and are capable of being bent so as to accommodate insertion of side edge 12 into slit 34 and side edge 14 into slit 36. In performing the insertion operation, it is seen that side edge 12 is rotated 180° about fold line 24 toward middle back side segment 22 with simultaneous bending of end back segment 18 with concomitant opening of slit 34 by outward bending of flap 38 to permit insertion of side edge 12. Opposed side edge 14 of bottom segment 20 is rotated 180° about fold line 26 toward the middle front side 32 of the middle segment with concomitant opening of slit 36 by bending of flap 40 to permit insertion of side edge 14. The description of outward and inward as used herein simply refers to the fact that the flaps are pushed in opposite directions to open the slit for appropriate end insertion.

While inwardly-facing slits 34,36 have been shown as semi-circular, there is no need to limit the invention to such, and in fact, it is possible that any m-sided polygon would work, provided that m is an integral value greater than or equal to 2. Also, while the invention has been illustrated as a tripartite card, there may be instances where n is greater than 3. In this embodiment, multiple additional segments may be interposed between middle segment 22,32 and end segment 20,30 and folded in an accordion-like manner for ultimate insertion of the last end segment into slit 36.

Additionally, while tripartite and higher segmented cards have been described to date, it is equally possible to have a two segment card, the distinction between that and the tripartite card described previously is the fact that the middle segment only has one inwardly facing slit for insertion of side edge 12 thereinto. Middle segment 22,32 thus becomes an end segment in this embodiment.

This invention has been described in detail with reference to specific embodiments thereof, including the respective best modes for carrying out each embodiment. It shall be understood that these illustrations are by way of example and not by way of limitation.

What is claimed is:

1. A foldable card which comprises:
(a) an elongated strip having at least a pair of outer segments and a middle segment, each segment separated by a fold line;
(b) said strip having a pair of longitudinal edges and a pair of side edges;
(c) said middle segment comprising two inwardly facing slits disposed within said middle segment; and
(d) each of said side edges being capable of insertion into and retention by one of said slits.

2. The card of claim 1 wherein
(a) said inwardly facing slits are semi-circular.

3. The card of claim 2 wherein
(a) said pair of outer segments are shorter than said middle segment.

4. The card of claim 3 wherein
(a) said pair of outer segments are shorter than said middle segment by a distance as measured by a length between said fold line and a terminal point of said slit.

5. The card of claim 4 wherein
(a) an outer segment of a front side of said elongated strip comprises business or personal indicia.

6. The card of claim 5 wherein
(a) a back side of said elongated strip comprises a ruler.

7. The card of claim 1 wherein
(a) said inwardly facing slits are m-sided polygons wherein m is an integral value greater than or equal to 2.

8. A foldable card which comprises:
(a) an elongated strip having two segments, each segment separated by a fold line;
(b) said strip having a pair of longitudinal edges and a pair of side edges;
(c) one of said segments comprising one inwardly facing slit disposed within said segment; and
(d) a side edge of said segment not containing said slit being capable of insertion into and retention by said slit.

9. The card of claim 8 wherein
(a) said inwardly facing slit is semi-circular.

10. The card of claim 9 wherein
(a) said segment containing said slit is longer than said segment which does not contain said slit.

11. The card of claim 10 wherein
(a) said segment containing said slit is longer than said segment which does not contain said slit by a distance as measured by a length between a side edge line of said segment containing said slit and a terminal point of said slit.

12. The card of claim 11 wherein
(a) an outer segment of a front side of said elongated strip comprises business or personal indicia.

13. The card of claim 12 wherein
(a) a back side of said elongated strip comprises a ruler.

14. The card of claim 8 wherein
(a) said inwardly facing slits are m-sided polygons wherein m is an integral value greater than or equal to 2.

15. A foldable card which comprises:
(a) an elongated strip having a pair of outer segments, a segment adjacent to one of said outer segments having a pair of inwardly facing slits disposed within said segment, and at least one other segment between said segment with said slits and said other outer segment, each segment separated by a fold line;
(b) said strip having a pair of longitudinal edges and a pair of side edges; and
(c) each of said side edges being capable of insertion into and retention by one of said slits.

16. The card of claim 15 wherein
(a) said inwardly facing slits are semi-circular.

17. The card of claim 16 wherein
(a) said segment having said pair of slits is longer than any other segment.

18. The card of claim 17 wherein
(a) said pair of segment having said pair of slits is longer than any other segment by a distance as measured by a length between said fold line and a terminal point of said slit.

19. The card of claim 18 wherein
(a) an outer segment of a front side of said elongated strip comprises business or personal indicia.

20. The card of claim 19 wherein
(a) a back side of said elongated strip comprises a ruler.

21. The card of claim 15 wherein
(a) said inwardly facing slits are m-sided polygons wherein m is an integral value greater than or equal to 2.
